(19) United States
(12) Patent Application Publication
(10) Pub. No.: US 2009/0284424 A1
(43) Pub. Date: Nov. 19, 2009

(54) ANTENNA MODULE, DISPLAY DEVICE HAVING THE SAME, AND INFORMATION PROCESSING SYSTEM HAVING THE SAME

(75) Inventors: Sang-Rock Yoon, Seoul (KR); Sung-Kyu Lee, Suwon-si (KR); Ki-Seob Lee, Suwon-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/465,952

(22) Filed: May 14, 2009

(30) Foreign Application Priority Data
May 15, 2008 (KR) 2008-44887

(51) Int. Cl. H01Q 1/22; H01Q 1/48; H01Q 1/36

(52) U.S. Cl. 343/702; 343/843; 343/845; 343/720

(57) ABSTRACT

An antenna module includes an antenna and a connection line. The antenna receives and sends a signal for wireless communication. The connection line includes a first terminal electrically connected to the antenna, a second terminal electrically connected to an external device and a grounding portion interposed between the first and second terminals.

This application claims priority to Korean Patent Application No. 2008-44887, filed on May 15, 2008, and all the benefits accruing therefrom under 35 U.S.C. §119, the contents of which in its entirety are herein incorporated by reference.

### BACKGROUND OF THE INVENTION

1. Field of the Invention

Embodiments of the invention relate to an antenna module, a display device having the antenna module, and an information processing system having the display device. More particularly, embodiments of the invention relate to an antenna module for wireless communication, a display device having the antenna module, and an information processing system having the display device.

2. Description of the Related Art

A liquid crystal display (“LCD”) can have a higher price and a lower display quality than a cathode-ray tube (“CRT”). However, the LCD device can be thinner, lower in weight and can have lower power consumption than the CRT device. Recently, a thin-film transistor (“TFT”) LCD device has been developed to have an image display quality that is substantially the same as that of the CRT device. Therefore, LCD devices are widely used in various display devices, such as large-screen televisions, notebook computers, portable terminals and cellular phones, which have small- or medium-sized screens.

Notebook computers are being developed as mobile Internet connection systems to support Internet businesses. Internet services can be available anytime and anywhere through the advances of wireless network technology such as wireless regional area network (“WRAN”) and wireless wide area network (“WWAN”) technology.

In an information processing system, a signal may be interfered with by reflection, rotation, multiplication or distortion, which can be received by an antenna for wireless communication as noise. For example, high frequency noise generated from a graphic card, a display module and an interface cable of a notebook computer may cause interference at the antenna for wireless communication.

In order to send and receive accurate data in the information processing system, such as a notebook computer for the wireless communication, it is desirable to reduce unexpected electrical and electromagnetic noise.

### BRIEF SUMMARY OF THE INVENTION

Exemplary embodiments include an antenna module capable of decreasing noise interference in wireless communication.

Exemplary embodiments include a display device having the antenna module.

Exemplary embodiments include an information processing system having the display device.

According to one aspect of an embodiment, disclosed is an antenna module. The antenna module includes an antenna, which receives and sends a signal for wireless communication, and a connection line. The connection line includes a first terminal electrically connected to the antenna, a second terminal electrically connected to an external device and a grounding portion interposed between the first and second terminals. The grounding portion is spaced apart from a terminal of the antenna by a distance corresponding to about a half wavelength of a substantial minimum frequency of the signal for wireless communication, and is disposed along the connection line. The connection line may further include a signal line, which transmits the signal, a grounding line, which surrounds the signal line and a coating, which surrounds the grounding line, and a portion of the coating may be removed to expose a portion of the grounding line, thereby forming the grounding portion. The coating may be disposed to cover a region between the grounding portion and the second terminal of the connection line. The grounding portion is disposed in an area between about 7.8 centimeters (“cm”) and about 9.8 cm from the terminal of the antenna when the substantial minimum frequency of the signal for wireless communication is 850 megahertz (“MHz”). The connection line may further include a plurality of grounding portions between the terminal of the antenna and the grounding portion.

According to another aspect, disclosed is a display device. The display device includes an antenna module, a lower case, a display module and an upper case. The antenna module includes an antenna, which receives and sends a signal for wireless communication, a connection line including a first terminal electrically connected to the antenna, a second terminal electrically connected to an external device, and a grounding portion interposed between the first and second terminals. The lower case includes a bottom plate, a plurality of side walls extending from sides of the bottom plate, a guiding part fixing the connection line to the bottom plate and the side walls and guiding the connection line, and a conductive material. The display module may include a panel assembly and a backlight assembly supplying light to the panel assembly. The display module may be an LCD, an OLED or another type of display module. An upper case is combined with the lower case and receives the antenna module and the display module.

The antenna module can include a first connection line electrically connected to a main antenna and an exposed grounding portion. The lower case includes a bottom plate, side walls extending from sides of the bottom plate, a guiding part fixing the connection line to the bottom plate and/or the side walls and guiding the connection line, and a conductive material. The display module includes a panel assembly. The display module may include a backlight assembly supplying light to the panel assembly. The upper case is combined with the lower case and receives the antenna module and the display module.

According to still another aspect, disclosed is an information processing system. The information processing system includes a display device including an antenna module including an antenna, which receives and sends a signal for wireless communication, a connection line including a first terminal electrically connected to the antenna, a second terminal corresponding to the first terminal and a grounding portion interposed between the first and second terminals, a lower case including a bottom plate, a plurality of side walls extending from sides of the bottom plate, and a guiding part fixing the grounding portion and guiding the connection line, a display module including a panel assembly and a backlight assembly supplying light to the panel assembly; an upper case combined with the lower case; and a data processing device including a signal processing part connected to the display device with a hinge connection, electrically connected to the second terminal of the connection line and which processes the signal; and an input part, which inputs data.

According to an embodiment, in an antenna module, a display device having the antenna module, and an information processing system having the display device, a grounding portion is disposed at a connection line, which is electrically connected to an antenna, so that noise interference in wireless communication may be efficiently decreased.

### BRIEF DESCRIPTION OF THE DRAWINGS

The above and other features, aspects and advantages of the present invention will become more apparent by describing in detail exemplary embodiments thereof with reference to the accompanying drawings, in which:

FIG. 1 is a perspective view illustrating an exemplary embodiment of an information processing system;

FIG. 2 is an exploded perspective view illustrating a display device of FIG. 1;

FIG. 3 is an enlarged perspective view illustrating a portion I of FIG. 2;

FIG. 4 is a perspective view illustrating an antenna module of FIG. 1; and

FIG. 5 is a graph illustrating noise distribution according to a location of a grounding portion shown in FIG. 4.

### DETAILED DESCRIPTION OF THE INVENTION

The present invention is described more fully hereinafter with reference to the accompanying drawings, in which exemplary embodiments are shown. The present invention may, however, be embodied in many different forms and should not be construed as limited to the exemplary embodiments set fourth herein. Rather, these exemplary embodiments are provided so that this disclosure is thorough and complete, and fully conveys the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

Exemplary embodiments of the invention are described herein with reference to cross-sectional illustrations that are schematic illustrations of idealized exemplary embodiments (and intermediate structures) of the present invention. As such, variations from the shapes of the illustrations as a result, for example, of manufacturing techniques and/or tolerances, are to be expected. Thus, exemplary embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present invention are further explained in detail with reference to the accompanying drawings.

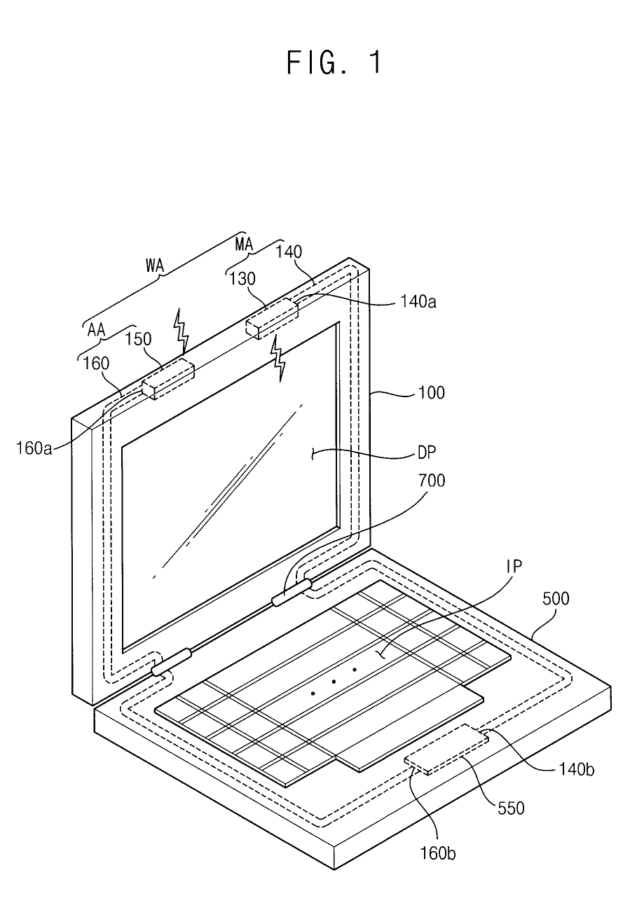

FIG. 1 is a perspective view illustrating an exemplary embodiment of an information processing system.

Referring to FIG. 1, the information processing system includes a display device 100, a data processing device 500 and a hinge part 700.

The display device 100 includes a display part DP and an antenna module WA. The display part DP has a rectilinear shape. The display part DP displays an image. The antenna module WA includes a main antenna module MA and an auxiliary antenna module AA. The main antenna module MA includes a main antenna 130 and a first connection line 140 connected to the main antenna 130. The first connection line 140 includes a first terminal 140a and a second terminal 140b. The first terminal 140a is electrically connected to the main antenna 130. The second terminal 140b is opposite to the first terminal 140a, and is electrically connected to a signal processing part 550.

The auxiliary antenna module AA includes an auxiliary antenna 150 and a second connection line 160 connected to the auxiliary antenna 150. The second connection line 160 includes a first auxiliary terminal 160a and a second auxiliary terminal 160b. The first auxiliary terminal 160a is electrically connected to the auxiliary antenna 150. The second auxiliary terminal 160b is disposed opposite to the first auxiliary terminal 160a, and is electrically connected to the signal processing part 550.

The main antenna 130 and the auxiliary antenna 150 receive signals having a frequency band for wireless communication. For example, wireless communication may include wireless communication over a wireless remote area network (“WRAN”), a wireless wide area network (“WWAN”), or the like.

Table 1 represents frequency bands and noise levels used in the Universal Mobile Telecommunications System (“UMTS”) and the Global System for Mobile communications (“GSM”). The Maximum Allowable Noise is an International Standard.

TABLE 1

| | | Maximum Allowable | |
|---|---|---|---|
| | Frequency Band | Noise | Antenna |
| Technology | (MHz) | (dBm) | Connected |
| 850 UMTS | 869-894 | −101 | ALL WWAN |
| 900 GSM | 925-960 | −113 | ALL WWAN |
| 1800 GSM | 1805-1880 | −113 | ALL WWAN |
| 1900 UMTS | 1930-1990 | −105 | ALL WWAN |
| 2100 UMTS | 2110-2170 | −102 | ALL WWAN |

*MHz refers to megahertz; dBm refers to decibels relative to one milliwatt

The data processing device 500 includes an input part IP and a signal processing part 550. The input part IP includes a user interface, which can used to input data to the information processing system. In an embodiment, the input part IP may include a keyboard and a mouse. The signal processing part 550 processes signals transferred from the first connection line 140 and the second connection line 160. The signal processing part 550 selects a desired signal from the signals transferred from the first connection line 140 and the second connection line 160. The signal processing part 550 processes the selected signal. In an embodiment, the signal processing part 550 may include a wireless network card. The signal processing part 550 decodes the received signal to generate a sending signal.

The hinge part 700 connects the display device 100 and the data processing device 500 in a hinge connection so that the display device 100 and the data processing device 500 may be more portable. In an exemplary embodiment, the information processing system may include a notebook computer.

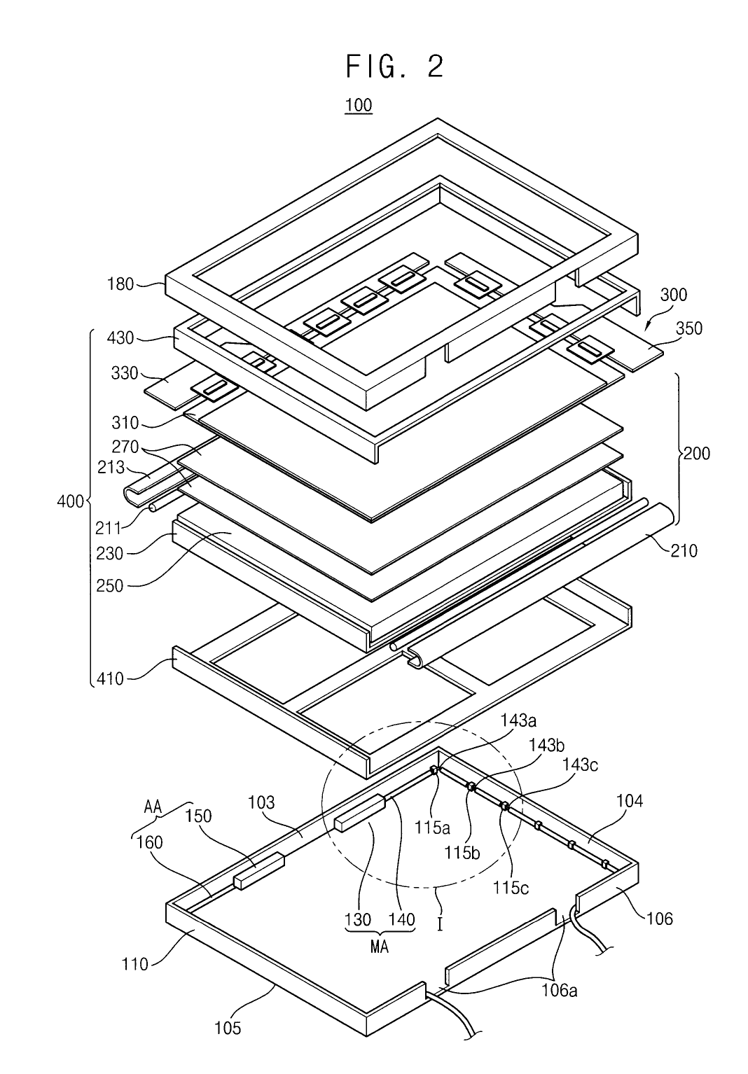

FIG. 2 is an exploded perspective view illustrating a display device of FIG. 1.

Referring to FIG. 2, the display device 100 includes a lower case 110, an upper case 180 and a display module 400.

The lower case 110 includes a bottom plate 101 and first, second, third and fourth side walls 103, 104, 105 and 106, respectively. The first, second, third and fourth side walls extend from sides of the bottom plate 101. The lower case 110 defines a receiving space. An inner surface of the lower case 110 is coated by a conductive layer. Alternatively, the lower case 110 may include a conductive material.

A main antenna module MA and an auxiliary antenna module AA are disposed on the lower case 110. The main antenna module MA includes a main antenna 130 and a first connection line 140 electrically connected to the main antenna 130. The first connection line 140 includes first, second and third grounding portions 143a, 143b and 143c, respectively. The auxiliary antenna module AA includes an auxiliary antenna 150 and a second connection line 160 electrically connected to the auxiliary antenna 150. The second connection line 160 includes a plurality of grounding portions (not shown).

The main antenna 130 and the auxiliary antenna 150 are placed on the bottom plate 101 adjacent to the first side wall 103 of the lower case 110. The first connection line 140 electrically connected to the main antenna 130 is fixed at a corner formed by the bottom plate 101, the first side wall 103 and the second side wall 104, and is fixed along an edge formed by the bottom plate 101, the first side wall 103 and the second side wall 104. The first side wall 103 and the second side wall 104 form a substantially right angle. The second connection line 160 electrically connected to the auxiliary antenna 150 is fixed at a corner formed by the bottom plate 101, the first side wall 103 and the third side wall 105, and is fixed along an edge formed by the bottom plate 101, the first side wall 103 and the third side wall 105. The third side wall 105 is opposite to the second side wall 104.

The first, second and third side walls 103, 104 and 105, respectively, include first, second, and third guiding parts 115a, 115b and 115c, respectively, fixing the first and second connection lines 140 and 160, respectively. Alternatively, the first, second and third guiding parts 115a, 115b and 115c can be disposed on the first, second and third side walls 103, 104 and 105 or the bottom plate 101, so that the first, second and third guiding parts 115a, 115b and 115c guide the first and second connection lines 140 and 160 disposed on the sides and fix the first and second connection lines 140 and 160. In an embodiment, the first, second and third guiding parts 115a, 115b and 115c may be electrically connected to the first, second and third grounding portions 143a, 143b and 143c of the first connection line 140 so that the first, second and third guiding parts 115a, 115b and 115c may fix the first connection line 140 to the first, second and third side walls 103, 104 and 105 and the bottom plate 101. Therefore, the first, second and third grounding portions 143a, 143b and 143c of the first connection line 140 may be electrically grounded to the lower case 110.

The first and second connection lines 140 and 160, fixed along the second and third side walls 104 and 105, are guided out of the lower case 110 through a plurality of holes 106a defined by a fourth side wall 106. The fourth side wall 106 is disposed opposite to the first side wall 103.

The upper case 180 is combined with the lower case 110. The upper case 180 and the lower case 110 receive the display module.

The display module includes a lower receiving container 410, an upper receiving container 430, a backlight assembly 200 and a panel assembly 300.

The lower receiving container 410 receives the backlight assembly 200 and the panel assembly 300. The upper receiving container 430 is disposed on the panel assembly 300, which is received in the lower receiving container 410 to cover the panel assembly 300. The upper receiving container 430 is combined with the lower receiving container 410. The lower and upper receiving containers 410 and 430 may include a conductive material. Alternatively, the lower and upper receiving container 410 and 430 may be coated by a conductive layer.

The backlight assembly 200 includes a lamp unit 210, a reflective member 230, a light guide plate 250 and an optical member 270. The lamp unit 210 is disposed in an area corresponding to the first and fourth side walls 103 and 106 of the lower case 110. The lamp unit 210 includes a lamp 211 generating light and a lamp cover 213 covering the lamp 211. The reflective member 230 is disposed on the lower receiving container 410. The reflective member 230 reflects the light generated by the lamp 211 to the light guide plate 250. The light guide plate 250 is disposed on the reflective member 230. The lamp unit 210 is disposed on ends of the lower receiving container 410, which face each other. The light guide plate 250 guides the light generated by the lamp 211 to the panel assembly 300. The optical member 270 is disposed on the light guide plate 250. The optical member 270 improves optical characteristics such as luminance uniformity and luminance when viewed from above or at an angle. In an embodiment, the optical member 270 may include a diffusion sheet diffusing the light and a prism sheet improving the luminance when viewed from above.

The panel assembly 300 includes a display panel 310, a data driving circuit 330 and a gate driving circuit 350. In an embodiment, the display panel 310 may include a liquid crystal display (“LCD”) panel, which includes a liquid crystal layer interposed between two substrates facing each other. The data driving circuit 330 provides a data signal to a data line disposed on the display panel 310. The gate driving circuit 350 provides a gate signal to a gate line, which extends in a direction substantially perpendicular to the data line on the display panel 310. In an embodiment, the data driving circuit 330 and the gate driving circuit 350 may include a tape carrier package (“TCP”) packaged with a driving chip and a printed circuit board (“PCB”) electrically connected to the TCP. In another embodiment, the data driving circuit 330 and the gate driving circuit 350 may be mounted on the display panel 310 or may be integrated on the display panel 310.

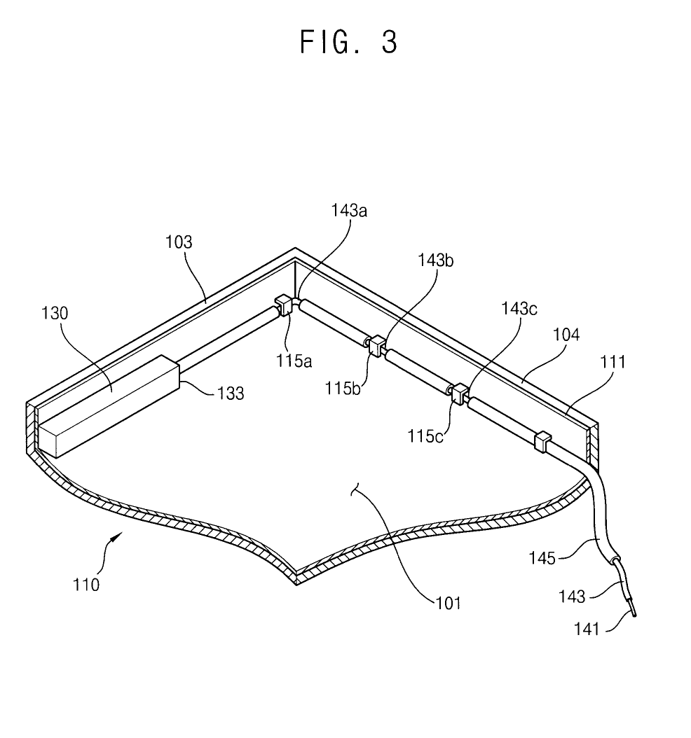

FIG. 3 is an enlarged perspective view illustrating a portion I of FIG. 2. FIG. 3 illustrates a main antenna module disposed on a lower case. Any repetitive explanation concerning an auxiliary antenna module disposed on the lower case is omitted.

Referring to FIGS. 1, 2 and 3, a conductive layer 111 is coated by a conductive material. The conductive layer 111 is disposed on the bottom plate 101 of the lower case 110 and the first, second, third and fourth side walls 103, 104, 105 and 106, respectively, extend from sides of the bottom plate 101. Exemplary conductive materials, which may be used for the conductive layer 111, include silver (Ag), aluminum (Al), or the like, or a combination comprising at least one of the foregoing conductive materials. These may be used alone or in a combination thereof Alternatively, the lower case 110 may include the conductive material.

The main antenna 130 is disposed at the edge formed by the first side wall 103 and the bottom plate 101. The first connection line 140, electrically connected to the main antenna 130, is fixed along the first and second side walls 103 and 104. The first side wall 103 and the second side wall 104 meet at a substantially right angle.

The first connection line 140 includes a signal line 141, a grounding line 143 and a coating 145. The signal line 141 transfers a signal received from the main antenna 130. The grounding line 143 wraps the signal line 141. The grounding line 143 includes a conductive material. The coating 145 wraps the grounding line 143. The coating material 145 includes an insulation material. The coating 145 is partially removed from the first connection line 140 and the grounding line 143 is partially exposed to the air so that first, second and third grounding portions 143a, 143b and 143c are formed. The first, second and third grounding portions 143a, 143b and 143c are disposed on a position corresponding to a half-wavelength of a wireless communication frequency band.

In an embodiment, when the main antenna 130 receives a signal of a wireless communication frequency band of 850 UMTS, 900 GSM, 1800 GSM, 1900 UMTS and 2100 UMTS, the third grounding portion 143c may be disposed in an area between about 7 centimeters (“cm”) and about 10 cm, specifically between about 8 cm and about 9 cm, more specifically about 8.8 cm from a terminal 133 of the main antenna 130. The distance of about 8.8 cm from the terminal 133 is substantially equal to a half-wavelength of a minimum frequency of a frequency band of 850 UMTS (about 869 MHz to about 894 MHz), which is a wireless communication frequency band.

Equation 1 represents a relationship between frequency (f) and wavelength (λ).

$$λ ( m ) = \frac{C}{f} , C = 3 \times {10}^{8} , \qquad Equation 1$$

wherein C is the speed of light, and f is a frequency.

According to Equation 1, a wavelength (λ) of signal having a frequency of about 850 megahertz (“MHz”) is about 0.352 meters (“m”). A quarter wavelength (λ/4) is about 0.088 m or about 8.8 cm. Accordingly, the third grounding portion 143c is disposed in an area between about 7 cm and about 10 cm, specifically between about 8 cm and about 9 cm, more specifically about 8.8 cm from the terminal 133. By disposing the third grounding portion 143c, the noise interference in the frequency band of about 850 MHz may be decreased.

A quarter wavelength (λ/4) of signal having a frequency of about 2100 MHz is about 3.6 cm. A quarter wavelength (λ/4) of signal having a frequency of about 1800 MHz is about 4.2 cm. Accordingly, the second grounding portion 143b is disposed in an area between about 3 cm and about 7 cm, specifically between about 4 cm and about 6 cm, more specifically about 5.8 cm from the terminal 133. By disposing the second grounding portion 143b, the noise interference in the frequency band of from about 1800 MHz to about 2100 MHz may be decreased. In addition, the first grounding portion 143a is disposed in an area between about 0.5 cm and about 3 cm, specifically between about 1 cm and about 2 cm, more specifically about 1.8 cm from the terminal 133. By disposing the first grounding portion 143a, the noise interference in the frequency band of over about 2100 MHz may be decreased.

In order to decrease the noise interference in all of the wireless communication frequency bands, the third grounding portion 143c is disposed in an area separated by a distance corresponding to a half-wavelength (λ/2) of the minimum frequency band for wireless communication from the terminal 133 of the main antenna 130. Also, the third grounding portion 143c may be disposed in an area separated by a quarter-wavelength (λ/4) of the minimum frequency band of the wireless communication from the terminal 133 of the main antenna 130. In addition, the first grounding portion 143a and the second grounding portion 143b may be disposed between the third grounding portion 143c and the terminal 133.

Accordingly, the first grounding portion 143a is disposed in an area between about 0.8 cm and about 2.8 cm, specifically between about 1 cm and about 2.5 cm, more specifically between about 1.2 cm and about 2.2 cm from the terminal 133 of the main antenna 130. In an embodiment, the first grounding portion 143a is disposed in an area about 1.8 cm from the terminal 133 of the main antenna 130. The second grounding portion 143b is disposed in an area between about 3 cm and about 7 cm, specifically between about 4 cm and about 6 cm, more specifically between about 4.8 cm and about 6.8 cm from the terminal 133 of the main antenna 130. In an embodiment, the second grounding portion 143b is disposed in an area about 5.8 cm from the terminal 133 of the main antenna 130. The third grounding portion 143c is disposed in an area between about 7 cm and about 10 cm, specifically between about 8 cm and about 9 cm, more specifically between about 7.8 cm and about 9.8 cm from the terminal 133. In an embodiment, the third grounding portion 143c is disposed in an area about 8.8 cm from the terminal 133 of the main antenna 130. The widths W of the first, second and third grounding portions 143a, 143b and 143c are each between about 0.1 cm and about 3 cm, specifically between about 0.5 cm and about 2 cm, more specifically about 1 cm.

In the first connection line 140, the coating material 145 wraps the grounding line 143 to cover the grounding line 143 from the third grounding portion 143c to the second terminal 140b, which is electrically connected to the signal processing part 550.

In the first and second side walls 103 and 104, first, second and third guiding parts 115a, 115b and 115c, respectively, fix the first connection line 140 along an edge formed by the bottom plate 101, the first side wall 103 and the second side wall 104. The first, second and third guiding parts 115a, 115b and 115c are coated by the conductive layer 111. The first, second and third guiding parts 115a, 115b and 115c are disposed in an area corresponding to the first, second and third grounding portions 143a, 143b and 143c of the first connection line. The first, second and third guiding parts 115a, 115b and 115c are electrically connected to the first, second and third grounding portions 143a, 143b and 143c, respectively. Accordingly, a grounding path is formed through the first, second and third grounding portions 143a, 143b and 143c, the first, second and third guiding parts 115a, 115b and 115c and the lower case 110 in the first connection line 140. In another embodiment, a grounding path may be formed through the lower receiving container 410, which is received in the lower case 110. The lower receiving container 410 includes a conductive material.

Hereinafter, disclosed is an exemplary embodiment wherein a grounding portion was formed at various locations, and an antenna module was tested based on the location of the grounding portion.

Here are some aspects of an embodiment. The antenna 130 is made of a conductive material and is exposed to the air. The antenna 130 is electrically coupled to the signal line 141. The antenna 130 may be made of the same material as the signal line 141. In this case, the antenna 130 may be divided from the signal line 141 by the coating 145 or the grounding line 143. That is to say, the antenna 130 may be an exposed portion to the air and the connection line may be a covered portion by the grounding line 143 and/or the coating 145. When the antenna 130 is made of a different material from the signal line 141, the antenna 130 is coupled to the signal line 141 by soldering or the like. There may be a plurality of grounding portions on the connection line 140 and the farthest grounding portion is at the substantially same position as the half wave length of the minimum frequency of the wireless communication signals.

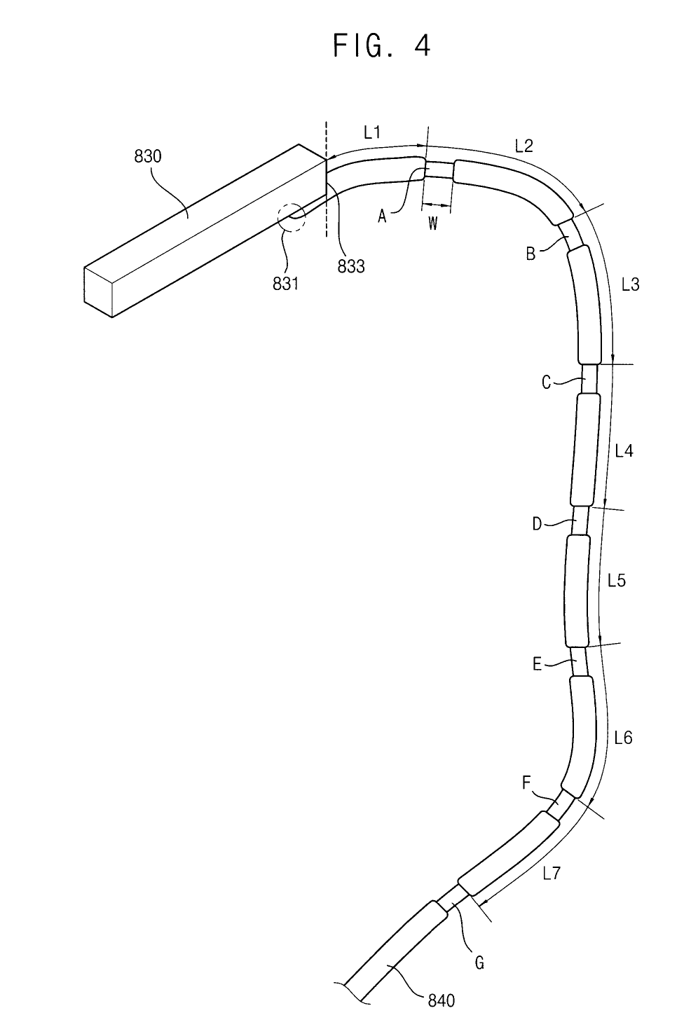

FIG. 4 is a perspective view illustrating an antenna module of FIG. 1.

Referring to FIG. 4, the antenna module includes an antenna 830, and a connection line 840 connected to the antenna 830. A terminal of the connection line 840 is electrically connected to a portion 831 of the antenna 830 by soldering. The insulation material is removed from the connection line 840 and the grounding line is exposed to the air to form first, second, third, fourth, fifth, sixth and seventh grounding portions A, B, C, D, E, F and G. The length of each grounding portion is about 1 cm.

Table 2 represents a location of the first, second, third, fourth, fifth, sixth and seventh grounding portions A, B, C, D, E, F and G.

TABLE 2

| Location of the Grounding | |
|---|---|
| Portion | Length (cm) |
| A | L1 = 1.8 |
| A-B | L2 = 5.8 |
| A-B-C | L3 = 8.8 |
| A-B-C-D | L4 = 11.8 |
| A-B-C-D-E | L5 = 14.8 |
| A-B-C-D-E-F | L6 = 17.8 |
| A-B-C-D-E-F-G | L7 = 20.8 |

Referring to Table 2, the first grounding portion A was formed in an area separated by a first length L1 of 1.8 cm from a terminal 833 of the antenna 830. The location of the terminal 833 of the antenna 830 corresponds to a direction extending from the connection line 840. The second grounding portion B was formed in an area separated by a second length L2 of 5.8 cm from the terminal 833 of the antenna 830. The third grounding portion C was formed in an area separated by a third length L3 of 8.8 cm from the terminal 833 of the antenna 830. The fourth grounding portion D was formed in an area separated by a fourth length L4 of 11.8 cm from the terminal 833 of the antenna 830. The fifth grounding portion E was formed in an area separated by a fifth length L5 of 14.8 cm from the terminal 833 of the antenna 830. The sixth grounding portion F was formed in an area separated by a sixth length L6 of 17.8 cm from the terminal 833 of the antenna 830. The seventh grounding portion G was formed in an area separated by a seventh length L7 of 20.8 cm from the terminal 833 of the antenna 830.

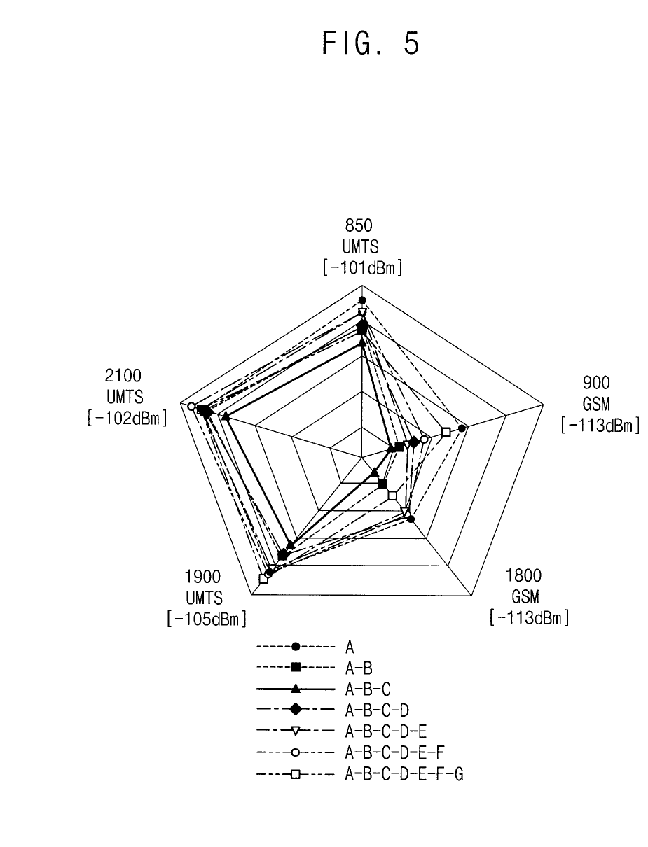

FIG. 5 is a graph illustrating noise distribution according to a location of a grounding portion shown in FIG. 4.

Table 3 represents noise distribution according to a location of a grounding portion and the wireless communication frequency band.

TABLE 3

| | 850 | 900 | 1800 | 1900 | 2100 |
|---|---|---|---|---|---|
| | UMTS | GSM | GSM | UMTS | UMTS |
| | (dBm) | (dBm) | (dBm) | (dBm) | (dBm) |
| Maximum Allowable | −101 | −113 | −113 | −105 | −102 |
| Noise | | | | | |
| Sample 1 | −92 | −101 | −104 | −94 | −93 |
| Sample 2 | −96 | −110 | −110 | −97 | −93 |
| Sample 3 | −98 | −111 | −112 | −99 | −96 |
| Sample 4 | −95 | −107 | −104 | −96 | −93 |
| Sample 5 | −93 | −108 | −105 | −94 | −92 |
| Sample 6 | −93 | −106 | −104 | −93 | −91 |
| Sample 7 | −96 | −103 | −108 | −92 | −93 |

*dBm refers to decibels relative to one milliwatt

Referring to FIGS. 4 and 5 and Table 3, Sample 1 represents the reception performance of the antenna 830 when the antenna 830 included only the first grounding portion A. When the frequency band was 850 UMTS, a noise level was about −92 dBm and the maximum allowable noise was −101 dBm. When the frequency band was 900 GSM, a noise level was about −101 dBm and the maximum allowable noise was −113 dBm. When the frequency band was 1800 GSM, a noise level was about −104 dBm and the maximum allowable noise was −113 dBm. When the frequency band was 1900 UMTS, a noise level was about −94 dBm and the maximum allowable noise was −105 dBm. When the frequency band was 2100 UMTS, a noise level was about −93 dBm and the maximum allowable noise was −102 dBm.

Sample 2 represents the reception performance of the antenna 830 when the antenna 830 included the first and second grounding portions A and B. When the frequency band was 850 UMTS, a noise level was about −96 dBm. When the frequency band was 900 GSM, a noise level was about −110 dBm. When the frequency band was 1800 GSM, a noise level was about −110 dBm. When the frequency band was 1900 UMTS, a noise level was about −97 dBm. When the frequency band was 2100 UMTS, a noise level was about −93 dBm.

Sample 3 represents the reception performance of the antenna 830 when the antenna 830 included the first, second and third grounding portions A, B and C. When the frequency band was 850 UMTS, a noise level was about −98 dBm. When the frequency band was 900 GSM, a noise level was about −111 dBm. When the frequency band was 1800 GSM, a noise level was about −112 dBm. When the frequency band was 1900 UMTS, a noise level was about −99 dBm. When the frequency band was 2100 UMTS, a noise level was about −96 dBm.

Sample 4 represents the reception performance of the antenna 830 when the antenna 830 included the first, second, third and fourth grounding portions A, B, C and D. When the frequency band was 850 UMTS, a noise level was about −95 dBm. When the frequency band was 900 GSM, a noise level was about −107 dBm. When the frequency band was 1800 GSM, a noise level was about −104 dBm. When the frequency band was 1900 UMTS, a noise level was about −96 dBm. When the frequency band was 2100 UMTS, a noise level was about −93 dBm.

Sample 5 represents the reception performance of the antenna 830 when the antenna 830 included the first, second, third, fourth and fifth grounding portions A, B, C, D and E. When the frequency band was 850 UMTS, a noise level was about −93 dBm. When the frequency band was 900 GSM, a noise level was about −108 dBm. When the frequency band was 1800 GSM, a noise level was about −105 dBm. When the frequency band was 1900 UMTS, a noise level was about −94 dBm. When the frequency band was 2100 UMTS, a noise level was about −92 dBm.

Sample 6 represents the reception performance of the antenna 830 when the antenna 830 included the first, second, third, fourth, fifth and sixth grounding portions A, B, C, D, E and E When the frequency band was 850 UMTS, a noise level was about −93 dBm. When the frequency band was 900 GSM, a noise level was about −106 dBm. When the frequency band was 1800 GSM, a noise level was about −104 dBm. When the frequency band was 1900 UMTS, a noise level was about −93 dBm. When the frequency band was 2100 UMTS, a noise level was about −91 dBm.

Sample 7 represents the reception performance of the antenna 830 when the antenna 830 included the first, second, third, fourth, fifth, sixth and seventh grounding portions A, B, C, D, E, F and G. When the frequency band was 850 UMTS, a noise level was about −96 dBm. When the frequency band was 900 GSM, a noise level was about −103 dBm. When the frequency band was 1800 GSM, a noise level was about −108 dBm. When the frequency band was 1900 UMTS, a noise level was about −92 dBm. When the frequency band was 2100 UMTS, a noise level was about −93 dBm.

In Sample 3, the noise was close to the maximum allowable noise from Sample 1 to Sample 7.

Therefore, when the antenna, having the grounding portion formed in the area separated by a distance of no more than about 8.8 cm from the terminal of the antenna, received the signal of the wireless communication frequency band of 850 UMTS, 900 GSM, 1800 GSM, 1900 UMTS and 2100 UMTS, the noise interference in the frequency band of 850 MHz was reduced. The distance of about 8.8 cm corresponded to the half-wavelength of the minimum frequency band of 850 MHz of the wireless communication frequency bands.

However, when the grounding portion was formed in an area separated by a distance of no less than about 10.8 cm (Samples 4, 5, 6 and 7), the noise interference in the wireless communication frequency bands was not removed. Also, when the grounding portion was formed in an area separated by a distance of no more than about 5.8 cm (Samples 1 and 2), the noise interference in the wireless communication frequency bands was not removed.

In an embodiment, forming a grounding portion in a connection line electrically connected to an antenna, the noise interference in a wireless communication band may be decreased. By forming a grounding portion separated by an area corresponding to the half-wavelength of the minimum frequency band of the wireless communication frequency bands, the noise interference in a wireless communication band may be decreased. Therefore, the reliability of an information processing device may be improved.

Although exemplary embodiments have been described, it is understood that the present invention should not be limited to these exemplary embodiments but various changes and modifications can be made by one ordinary skilled in the art within the spirit and scope of the present invention as hereinafter claimed.

What is claimed is:

1. An antenna module comprising:
an antenna, which receives and sends a signal for wireless communication; and
a connection line including a first terminal electrically connected to the antenna, a second terminal electrically connected to an external device and a grounding portion interposed between the first and second terminals.

2. The antenna module of claim 1, wherein the grounding portion is spaced apart from a terminal of the antenna by a distance corresponding to about a half wavelength of a minimum frequency of the signal for wireless communication, and is disposed along the connection line.

3. The antenna module of claim 2, wherein the connection line further comprises a signal line, which transmits the signal, a grounding line, which surrounds the signal line and a coating, which surrounds the grounding line, and
wherein a portion of the coating is removed to expose a portion of the grounding line, thereby forming the grounding portion.

4. The antenna module of claim 3, wherein the coating is disposed to cover a region between the grounding portion and the second terminal of the connection line.

5. The antenna module of claim 2, wherein the grounding portion is disposed in an area between about 7.8 centimeters and about 9.8 centimeters from the terminal of the antenna when the minimum frequency of the signal for wireless communication is 850 megahertz.

6. The antenna module of claim 2, wherein the connection line further comprises a plurality of grounding portions between the terminal of the antenna and the grounding portion.

7. A display device comprising:
an antenna module including:
an antenna, which receives and sends a signal for wireless communication;
a connection line including a first terminal electrically connected to the antenna, a second terminal electrically connected to an external device, and a grounding portion interposed between the first and second terminals;
a lower case including a bottom plate, a plurality of side walls extending from sides of the bottom plate, a guiding part fixing the connection line to the bottom plate and the side walls and guiding the connection line, and a conductive material;
a display module including a panel assembly and a backlight assembly supplying light to the panel assembly; and
an upper case combined with the lower case and receiving the antenna module and the display module.

8. The display device of claim 7, wherein the grounding portion is spaced apart from a terminal of the antenna by a distance corresponding to about a half wavelength of a minimum frequency of the signal for wireless communication, and is disposed along the connection line.

9. The display device of claim 8, wherein the connection line further comprises a signal line, which transmits the signal, a grounding line, which surrounds the signal line and a coating, which surrounds the grounding line, and
wherein a portion of the coating is removed to expose a portion of the grounding line, thereby forming the grounding portion.

10. The display device of claim 9, wherein the coating is disposed to cover a region between the grounding portion and the second terminal of the connection line.

11. The display device of claim 8, wherein the grounding portion is disposed in an area between about 7.8 centimeters and about 9.8 centimeters from the terminal of the antenna when the minimum frequency of the signal for wireless communication is 850 megahertz.

12. The display device of claim 8, wherein the connection line further comprises a plurality of grounding portions between the terminal of the antenna and the grounding portion.

13. The display device of claim 7, wherein the guiding part is disposed on the side walls or the bottom plate along an edge formed by the side walls and the bottom plate.

14. The display device of claim 13, wherein the antenna is disposed on the bottom plate and adjacent to a first side wall of the side walls, and
wherein the connection line extends along the first side wall and a second side wall, which is adjacent to the first side wall, and the connection line is fixed at the lower case by a plurality of the guiding parts disposed at an edge formed by the first and second side walls and the bottom plate.

15. The display device of claim 7, wherein the display module further comprises:
a lower receiving container receiving the lower case and including a conductive material;
a backlight assembly received by the lower receiving container and including a lamp generating light;
a panel assembly disposed on the backlight assembly and including a liquid crystal display panel, which displays an image; and
an upper receiving container combined with the lower receiving container and receiving the backlight assembly and the panel assembly.

16. An information processing system comprising:
a display device including:
an antenna module including an antenna, which receives and sends a signal for wireless communication; a connection line including a first terminal electrically connected to the antenna, a second terminal corresponding to the first terminal and a grounding portion interposed between the first and second terminals;
a lower case including a bottom plate, a plurality of side walls extending from sides of the bottom plate, and a guiding part fixing the grounding portion and guiding the connection line;
a display module including a panel assembly and a backlight assembly supplying light to the panel assembly;
an upper case combined with the lower case; and
a data processing device including:
a signal processing part connected to the display device with a hinge connection, electrically connected to the second terminal of the connection line and which processes the signal; and
an input part, which inputs data.

17. The information processing system of claim 16, wherein the grounding portion is spaced apart from a terminal of the antenna by a distance corresponding to about a half wavelength of a minimum frequency of the signal for wireless communication, and is disposed along the connection line.

18. The information processing system of claim 17, wherein the connection line further comprises a signal line, which transmits the signal, a grounding line, which surrounds the signal line and a coating, which surrounds the grounding line, and
wherein a portion of the coating is removed to expose a portion of the grounding line, thereby forming the grounding portion.

19. The information processing system of claim 18, wherein the coating is disposed to cover a region between the grounding portion and the second terminal of the connection line.

20. The information processing system of claim 17, wherein the connection line further comprises a plurality of grounding portions between the terminal of the antenna and the grounding portion.
